(19) United States
(12) Patent Application Publication
(10) Pub. No.: US 2007/0086043 A1
(43) Pub. Date: Apr. 19, 2007

(54) System and method for creating personalized laminated structures from dissimilar substrates

(75) Inventor: Jesse D. Crum, Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/253,886

(22) Filed: Oct. 19, 2005

(51) Int. Cl. G06F 3/12

(52) U.S. Cl. 358/1.15; 358/1.18

(57) ABSTRACT

A system and method for creating personalized printed laminates from dissimilar substrates is described and enables the traditional manufacturers of business communications to produce a series of highly individualized imaged materials at a relatively high resolution level. The system and method of the present invention permits the creation of unique products, such as those used in consumer goods packaging, marketing collateral and advertising pieces through the creation of laminates that have a relatively thick core with a thin high quality printed upper layer that could otherwise not be processed through conventional print manufacturing equipment.

### CROSS-REFERENCES TO RELATED APPLICATIONS

None.

### FIELD OF THE INVENTION

The present invention is found in the field of automated systems for producing high quality, high resolution personalized laminates from dissimilar substrates. The system described in the instant specification enables the preparation of a variety of individualized laminates from a plethora of available stock materials. More particularly, the invention is directed to the production of a number of individually imaged substrates or sheets which may then be cut into individual segments, ribbons or strips, with each strip having a pre-printed area pertaining to a specific, personalized job. Through the inclusion of a unique placer mechanism, the segments or ribbons may be placed individually and directly on varying webs or sheets of material for processing and ease of handling. The subsequent web or sheet laminate intermediate may then be subjected to additional processing steps to segregate the individual jobs for delivery to the end user customer.

The segments or ribbons, which are intended to represent discrete, individualized printed sheets, with each printable area representing a specific order, can be used for a number of printed communication pieces such as may be used for advertising, marketing, promotional activities and the like. The sheets are produced in part, initially from a pre-imaged or pre-printed sheet that may then be converted or merged to either a roll type of format through use of a placer mechanism or to a number of individual sheets that may be stacked until ready for use.

The sheets are initially printed with high quality graphics or images that relate to the specific or individual order. The sheets are then slit or cut to size to form templates, ribbons, surface elements or segments, with each template ranging in size from an inch square to the face of an entire sheet surface. The segments are then converted to or merged with a continuously advancing web or one or more sheets to create an intermediate laminate by placing the individual segments on the web or sheet in a sequential fashion. The segments that have been affixed to the web or sheet are then provided in one or more intermediate configurations to an end user. More particularly, the present invention can be used to create distinctive laminates that can be further manipulated to produce a variety of laminated products that have a high or photo quality resolution level such as those greater than about 150 lines per inch and still preferably greater than about 300 lines per inch or approximately 2500 to 3500 dots per inch.

### BACKGROUND OF THE INVENTION

There are currently a plethora of office products, business form constructions and other stationery items that are available in the market today and yet with this inordinately large selection of offerings and permutations, there remains a continuing need to develop new products due to changes in technology, societal trends, diversification and new information handling needs of businesses and consumers alike.

However, while printed products, such as pieces and other assemblies that are intended to be used in business communications, can be delivered in a wide variety of formats, constructions and configurations, the manufacturing of such diversified products may simply be unattainable by most producers of such products, particularly smaller sized manufacturers.

Traditional manufacturers of business communications, such as business forms and labels, are also usually limited in the type of jobs that a manufacturer will accept based on size of the job, types of materials that are to be utilized or the order quantity or value of the order. For example, due to cost factors, a customer will not place an order with a manufacturer for a small to medium sized piece quantity as the set up or make ready of the job makes the order cost prohibitive, even assuming that the manufacturer would accept the order if a particular price could be obtained to justify production. A manufacturer may also reject a job due to the particular substrates that are needed in order to produce an order as the thickness of the material simply will not traverse the apparatus.

As mentioned above, equipment may be further limited by the type of stocks or substrates that can be effectively handled or processed by such presses thereby further limiting the potential output of the types of products from manufacturers. For example, board or tag stocks are exemplary materials that due to the thickness of the substrate cannot be handled by most types of printing equipment and thus cannot printed upon by such conventional technologies as flexographic.

Flexography is one exemplary conventional technology that is commonly used today for the printing of decorative items, because of the ability to print multiple colors. However, flexography is one exemplary technology that suffers from the foregoing drawbacks.

Flexographic technology is commonly used today in the rendering of film packaging, marketing communications and normally will utilize a series of plates and one or more stations, containing inks; to apply colored images to the web as the web traverses the press. Through improvements in ink qualities and other modifications and enhancements in the technology, the image quality in flexographic presses and resulting products has improved to about 150 lines per inch. In addition, flexographic printing presses are also limited by the thickness of the substrates that can be effectively handled and processed by the equipment.

Typically, for a point of reference, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

While use of such conventional technology such as flexography is desirable in the printing of films and other relatively thin materials due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy”. Other images such as those that use flesh tones or deep or rich colors, may look faded or “washed out”. The effects of this level of image resolution can detract from the product appearance which may diminish the value of the technology and the products produced. With increasing sophistication of consumers, as well as technology and expectations from each, such effects may be undesirable to potential end users.

The market for printed communication material is also changing and becoming more sophisticated. Such conventional business forms manufacturers have normally produced product runs that range in the hundreds of thousands to millions or even tens of millions of pieces for a single order. These single orders may be produced for example in connection with a multiple part medical form product, insurance form or the like. As such, the equipment that is used to produce product at these levels or quantities is then set up to handle only large manufacturing runs. The apparatus used in this type of fulfillment will normally only operate efficiently in this higher range of production quantities and often cannot be reconfigured as the apparatus has been constructed in such a specific manner so as to be able to optimize production efficiencies of these larger runs. Thus, even if a manufacturer wished to pursue smaller runs, orders sizes or utilized different substrates, the manufacturer is faced with the dilemma of making new capital expenditures to purchase equipment that specializes in this type of application. This along with the possibility of having to retrain existing personnel or hire and train new employees to generate this type of production activity places additional constraints on the decision making process.

Traditional manufacturers of business communications, such as business forms and labels, may also be limited in the type of jobs that a manufacturer will accept. These additional factors may include the size of the job, or more particularly the order quantity or value of the order. That is, due to cost factors, a customer will not place an order with a manufacturer for a small to medium quantity of pieces or if different substrates are required as the set up or make ready of the job makes the order cost prohibitive, even assuming that the manufacturer would accept the order if a particular price could be obtained to justify production.

A still further drawback of trying to migrate to smaller or individualized customer applications relates to quality of the pieces that need to be generated. With the focus of the market slowly shifting to smaller runs, the end user is now demanding a greater image quality than that typically associated with conventionally printed products. It is believed that one of the reasons for such far reaching changes is that budgets for marketing and business communications have been cut back in recent years and as such, end users want more from each piece that is produced rather than relying on the quantity of pieces to generate the desired result. In addition, marketers want to make a greater impact at every turn in the retail chain to try and maximize the chances for purchases of a particular product being offered.

With the change in focus to quality as opposed to quantity there are a number of products that to date are still out of reach of conventional manufacturers in that certain materials are simply to thick or unwieldy to be able to be handled by printing equipment and forms processing apparatus.

In addition, with the rise of consumer oriented warehouses, superstores, shopper's and price clubs, discount chains, “big box retailers” and the like, many products that are intended for retail or consumer use are never removed from their shipping package or container. Instead, these relatively bland packages are placed on pallets on the floor or on shelves and the consumer merely load the package into his or her cart and then remove the goods from the package upon arrival at one's home. Thus, such conventional packaging does little in the way of marketing or encouraging point of sale type activity to entice a consumer to purchase one product over another. In this age of brand marketing, and positioning of products in the consumer focus, so much of the effort associated with advertising and marketing to the consumer is then lost, as the package does not necessarily complete the image that the manufacturer of the consumer good wishes to convey to prospective customers.

While some cartons may have printed sheets providing a picture of the product applied exteriorly to the carton, those sheets do not typically cover the face of the side of the carton to which the sheet has been applied and may in fact detract from the quality of the product. In addition, it often appears as if the sheet was applied post packaging, which is in fact typically the situation. In such instances, the sheets can appear splayed or crooked on the surface, may bubble up due to incomplete lamination or sloppy application of the sheet to the carton, may rip or tear upon handling during shipping or simply be removed from the exterior of the carton thereby defeating the purpose of applying the sheet. As such, a more effective and aesthetically appealing point of sale vehicle is needed for such bulk retail applications.

What is needed therefore is an economical and efficient system and method by which a conventional print manufacturer can produced highly customized small to medium sized orders in a highly personalized manner while using high quality, high resolution imaging equipment and a number of different substrates to create effective business communication platforms.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention seeks to provide a laminated assembly, either in an intermediate or finished product configuration in an efficient and cost effective manner. The first sheet that will form one of the exposed layers of the laminate will typically have printing or imaging that includes graphical or resolution quality of about 150 or more lines per inch and preferably more than 300 lines per inch, which is approximately equal to about 2500 to 3500 dots per inch (“DPI”) in order to create a high quality imaged product that is intended to be aesthetically appealing to the consumer and to more effectively communicate the business message of the application in the small to medium range market applications. The base or core of the laminate will typically be a material that has not customarily been used in provided business communication products, either due to the thickness of the material or alternatively due to the inability of the material to effectively hold out or retain print.

Unexpectedly, it has been found that relatively thick materials, such as corrugated substrates, heavy board and tag stocks and other stock material that has been difficult to handle have heretofore not been produced with high quality graphics due to limitations inherent in conventional manufacturing equipment. The present invention is directed toward a novel construction that enables the printing of relatively thin materials so as to obtain significantly improved graphics and imaging quality. These materials may then be laminated on to thicker base substrates to create enhanced marketing platforms in an effort to improve the aesthetic attributes of the consumer offering. The preparation of printed laminates in the fashion described in the present invention enables conventional business forms manufacturers to provide customers with a highly attractive product that may be utilized in a number areas including, marketing avenues or applications that have not been previously served by high end graphic products. It should be understood, that the invention can be used in connection with variously sized stocks ranging from thin stocks to relatively thick stocks ranging to several times the thickness of the first stock.

In one exemplary embodiment of the presently described invention, a system for producing business communication laminates in small to medium quantities is provided and includes an order entry device for matching order criteria obtained from a first source to available order parameters located at a second source that is distinct from the first source. The system further includes a high resolution imaging device that is located at the second source and a database that contains a number of the order parameters for producing a high resolution laminate.

A computer, such as a personal computer, is provided and is connected to the high resolution imaging device, the order entry device and the database. The computer is used to provide a series of printing instructions to the high resolution imaging device based on the order parameters obtained from the database.

A first group of materials that is used in the production of the business communication laminates of the present invention includes a number of individual printable sheets with each sheet having a first basis weight. A second group of individual materials are provided and used in the manufacture of the laminates described in this invention. The second group has distinct properties from the first group of materials with the distinction including for example, basis weight of the sheet of material.

A pre-laminate manufacturing unit is provided and is used for juxtaposing a printed sheet from the first group on at least one material from the second group. At least one laminating nip is then used for laminating the printed sheet from the first group to the at least one material selected from the second group to create a point of sale business communication laminate having a high resolution image.

In a still further exemplary embodiment of the present invention, a method for producing business communications for point of sale applications is described and includes the steps of, initially, providing a first database, the database including a number of job production parameters that are available at a manufacturing site. Next, job production information is collected from a first source at a site distinct from the manufacturing site. Then, the job production information from the first source is compared to the job production parameters. Imaging information is then created and is based on the job production information and the job production parameters. A first group of printable materials is supplied and the printable materials have a basis weight that ranges from ten to fifty pounds. A material is selected from a second group of materials and is used for forming a supporting core based on the job production information, the second group of materials has a basis weight that is different than the first group.

Continuing with a description of the presently described embodiment, a high resolution image is created on at least one printable sheet from the first group with the image having a resolution of greater than about 150 lines per inch. Then at least one printable sheet is juxtaposed on a material selected from the second group and the at least one printable sheet is laminated to the material from the second group to create a laminated point of sale business communication product.

The foregoing described method may also include a step of modifying the job production information after the step of comparing the job production information from the first source to the job production parameter and a step of calculating delivery parameters of said point of sale business communication laminate after the step of laminating.

A further step of soliciting point of sale business communication laminate orders may be included in the presently described method, with the solicitation activity being directed at a group of distributors of business communication products at any time prior to the step of laminating.

The foregoing method may also include a further step of printing a second printable sheet and applying the second printable sheet to a face of said material opposite that of the first printable sheet.

In a yet still further embodiment, a system for producing personalized business communication laminates is presented and includes a pre-determined group of printable sheets, with each sheet having a first thickness and a pre-selected group of base sheets, with each base sheet having a second thickness, that is distinct from said first thickness.

The system further includes an order confirmation system that has a database that contains a number of available manufacturing parameters and for determining available materials for forming a business communication laminate. A computer is connected to the database for matching the manufacturing parameters in response to a request for production of a business communication laminate and for creating a manufacturing sequence. A high resolution imaging device is connected to the computer for printing a high resolution image on at least one printable sheet in response to commands received from the computer.

The system also includes a post printing station for laminating the at least one printable sheet to one of the base sheets to create a business communication laminate and a laser die cutting station for cutting the business communication laminate in connection with the request.

The business communication laminate prepared in accordance with the above mentioned method or through use of either of the described systems may be selected from a group including marketing collateral, advertising pieces, consumer package goods and combinations thereof.

The systems may also include a request solicitation module for soliciting orders from a group of predetermined distributors of business communication materials and a vision inspection system that is connected to the computer for confirmation of the manufacturing parameters in response to the request.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a schematic of an exemplary system that is used in carrying out the present invention;

FIG. 2 provides a block diagram of an exemplary method that is used in making the business communication laminates of the present invention;

FIG. 3 shows a cross sectional view of a laminated prepared in connection with the present invention; and

FIG. 4 illustrates a front view of a business communication laminate prepared in accordance with the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

With the rise of large consumer goods outlets such as big box retailers, warehouse and shoppers clubs and the like, a need has developed to create an effective package that will stimulate sales of products while the product remains in its shipping or packaging container. Such packages need to be created in an integrated fashion to overcome the drawbacks identified above and the manufacturer of such products needs to be able to leverage the latest in high resolution imaging technology that heretofore has not been available for such applications.

The inventors of the instant specification have discovered that such a package as well as other unique business communications media can be created through the novel application of multiple technologies to create an advanced pacakge design. The present invention is used in preparing a business communication piece in either an intermediate form or one that is suitable for immediate use or application, such as in a package for bulk retail application. The invention utilizes high resolution imaging technology to prepare a first substrate or material with high quality graphics and then the first substrate is laminated, preferably permanently, to a second or base substrate. The substrates that are used in connection with the manufacture of the laminate preferably have significantly different thicknesses, with the second substrate or base material having a thickness or basis weight that is at least two times that of the first substrate and likely three or more times that of the first substrate or material.

The laminate prepared in connection with the present invention may find use in a number of applications, such as packaging for consumer products, including those corrugated packages that are commonly used for electronics, home and office products, house wares and the like. The laminate may also be used in creating signage, floor and point of display “talkers” and other unique applications. The present invention finds its particular niche in preparing packaging, advertising and marketing collateral for use in large retail outlets such as “big box” retailers, warehouse and shopper's clubs and the like.

As used herein the term “business communication” is used to refer to a printed or imaged piece, document or substrate that when used as a laminate as described in the present invention will convey a particular message, image or provide information about a particular product or service that is available from the provider of such pieces or documents. Business communication laminates, documents or pieces can include advertising, sales and marketing collateral and such other items used to convey information.

The term “personalized information” refers to information that is printed or imaged onto a substrate or document which is generally variable or unique and which may change from laminate to laminate so as to create a customized message or communication for each recipient. Examples of personalized information may include names, addresses, descriptions, plans, coding, numbering, promotional text, recipes based on contents, etc. that may have been acquired from the intended recipient through surveys, questionnaires or answers given to various inquiries generated in response to a request for goods or services.

The term “static or fixed” information refers to printed or imaged information that generally does not change from laminate to laminate and may include a general description or body of information about particular products, services, places, etc. that may be of interest to the intended recipient and represents a standard message that the manufacturing or supplier wishes to convey to an end user or customer of the offering.

The term “intermediate” as used herein refers to a product that undergoes one or more processing steps prior to the intermediate reaching a final condition, that of being ready for end use or application. The additional processing steps may include printing, imaging, folding, forming, sealing, separating, cutting, perforating, scoring, adhering and the like. Typically, a product such as with the present invention is provided in an intermediate condition so that a user or downstream manufacturer can add or manipulate the intermediate to create the final or desired end product, such as creating a carton or the like. Thus, in accordance with the present invention, the intermediate segment for example, could be subject to die cutting or additional printing, such as through ink jetting, over laminating, coating or embossment, and then applied to a container, carton, consumer package good or the like.

The phrase “bulk retail applications” refers to consumer outlets such as warehouse clubs, shopper's clubs, large retail stores, “big box” stores, superstores, price clubs, discount chains and combinations thereof where members of the general public may enter either with or without membership credentials.

Printable substrates are normally purchased in accordance with its weight per unit area. The area is normally that of a 500 sheet ream cut to a specified sized (“ream size”). For example, if a certain grade of paper has a specified ream size of 17×22 inches, the actual weight of 500 sheets in that size is the basis weight. A sheet with a 20 pound basis weight may be identified as 20-lb. or 20# and is customarily used in desktop printers and office use. Heavier bonds such as vellum may range from 60 to 80 pounds, Bristol board from 90 to 100 bounds and tag stock for example from 80 to 110 pounds and higher.

Examples of image generating or high quality printing devices that are suitable for use in practicing the invention include high resolution imaging devices such as Indigo®, available from Hewlett Packard of Palo Alto, Calif. or Karat available from KBA of Williston, Vt. Ideally, the present invention seeks to provide a segment or intermediate with a series of segments that has a quality of about 150 or more lines per inch and preferably more than 300 lines per inch, which is approximately equal to about 2500 to 3500 dots per inch (“DPI”) in order to create a high quality image that is intended to be aesthetically appealing to the consumer.

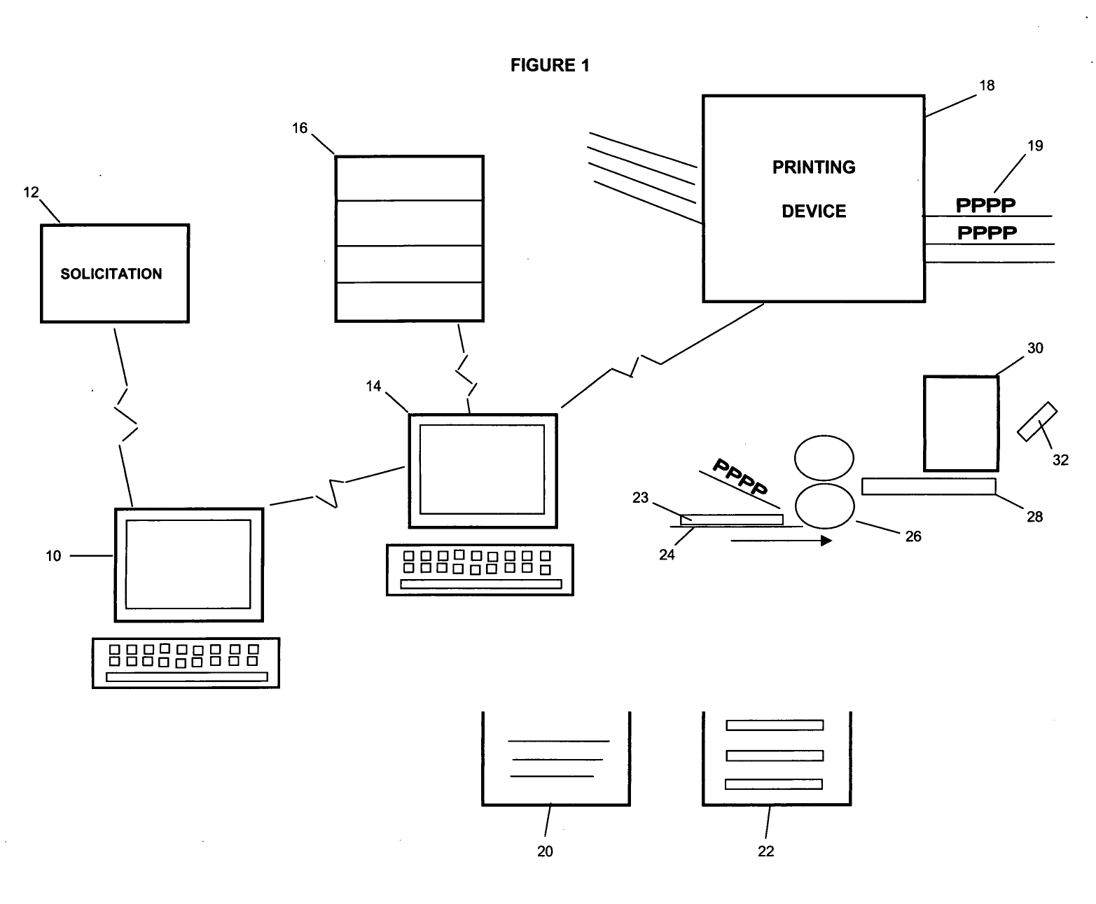

Reference is now directed to FIG. 1 which depicts a schematic of an exemplary system used in connection with carrying out the present invention. The system includes an order entry device 10, such as a personal computer that may be configured with print job software so that a user can populate the various fields with information received from the requestor. The order entry device 10 may be connected to or contain a module 12 that is used in solicitation of print orders from distributors whose primary business is the sale or resale of business communication products and services. The module 12 may include a database that contains information, such as phone, address, name and the like of distributors engaged in this line of business. The module 12 may also use telephone lines, a global communications network and the like to contact potential suitors for production of business communication laminates.

The order entry device 10 is also connected to a computer 14 that is used to operate the production equipment. The computer 14 is connected to a database 16 that contains a number of print production parameters, such as available colors, coatings, sheet sizes, and the like which may be used in the creation of business communication substrates. The computer 14 uses the information contained in the database 16 to match the incoming print job from the order entry device 10 to ensure that the order can be produced using the equipment on hand.

The system also includes a high quality image resolution device 18 that is used to render printed information on a printable substrate. The image resolution device 18 receives print information from the computer 14 and then either directly or through use of a printing plate applies images directly to a sheet of printable material as is shown on the output end 19 of the imaging device 18.

The system also includes a supply of printable stock materials 20 which will ideally have a basis weight ranging from about ten pounds to about fifty pounds. Individual sheets from this supply 20 will be used to create the upper layer of the laminate. In arrangements where the laminate will have two faces, one on each side of a core, a second sheet from supply 20 will be printed and used for this purpose. Obviously, different thickness or types of materials may be used. A second supply or group of material is provided at 22. The sheets of the second group 22 will preferably have a basis weight ranging from about fifty pounds to about one hundred fifty or more.

Once the upper most sheet has been printed, the printed sheet 19 is then passed to a pre-lamination point 24 where a sheet from the second supply 22 is positioned to receive the printed sheet 19. The sheet from the second supply may be provided with adhesive to bond the printed sheet 19 to the base or core sheet 23. The printed sheet 19 and core sheet 23 are then passed through one or more lamination nip points represented by numeral 26 where the printed sheet 19 is bonded to the core sheet 23 to produce a laminate 28 which may be in an intermediate form. The laminate 28 may then be passed through a die cutting station 30 to produce the final configuration of the laminate. A vision inspection system 32 may also be provided to inspect the laminate and compare the finished product to the original request received at the order entry device 10.

As used herein, the components of the system may be connected to one another through a local area network, wide area network or over a global communications network.

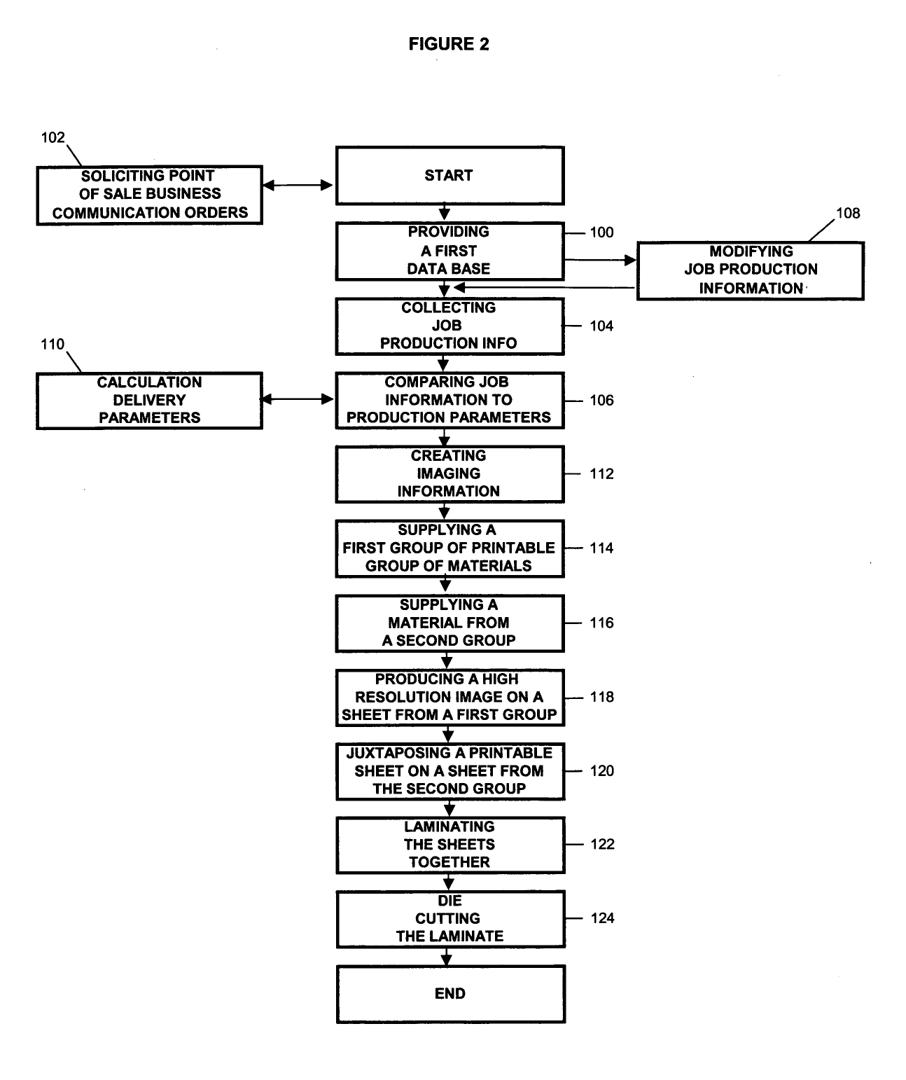

Turning now to FIG. 2 of the present invention which provides a block diagram setting forth an exemplary method for practicing the present invention. The process is started by the establishment or creation of a database 100 that contains information relating to manufacturing production parameters, such as inks, over coatings, available die for shaped products, presses for manufacturing the order and such other information as is normally customary in the industry. Either simultaneously with the creation of the database or at some other time a module 102 may be created in order to solicit orders for the manufacturing process. This module 102 can contain information on prospective purchasers of products, including names, addresses, contact numbers and the like.

Once an order is placed, job information is collected at step 104 and then the information of the order is compared with job production parameters at step 106. Depending on the result of the comparison conducted at step 106, the print job manufacturer may modify the job parameters at step 108 in order to bring the job into conformity with the available manufacturing parameters at the production facility.

During the job preparation steps, which include the steps of collecting job information 104, comparison of the job parameters with production information 106, and comparison of job information with production parameters 106, a further step 110 of calculating delivery parameters at step 110 in order to be able to fully price out the production of the job. The delivery parameters may be calculated such as by using various matrices or indices of freight companies to determine the most logical and economical shipping to deliver the laminate to the customer.

Next, imaging information is created at step 112, typically through files that are digitally created. The image is likely refined during this process and checked for color correctness, and then spelling of any textual information may be corrected or modified as may be necessary.

A first group of materials is provided at step 114. This first group of materials will ideally be a collection of printable sheets and will typically have a basis weight of about ten pounds to about fifty pounds. However, it should be understood that lighter as well as heavier materials may be used as the printable sheet stock. The first group of materials will be used as the exposed face or faces of the laminate. That is, one printable sheet may be used on one surface of the laminate or alternatively, such as in an advertising format, a second printable sheet may be used and applied to the second face of the laminate.

A second group of materials is supplied at step 116. The second group will preferably have a basis weight of about fifty pounds to about one hundred fifty pounds and will provide the core or base of the laminate on to which one or more of printable sheets provided in step 114 is applied.

Next, a high resolution image is produced at step 118 and is printed on a face of the printable sheets. The high resolution image is preferably produced at a resolution quality of greater than about 150 lines per inch. The printed sheet is then juxtaposed on to the surface of the core or base sheet at step 120. The printed sheet may be of roughly equivalent surface area as the core or may be smaller than the surface area of the core material. The two layers of material are then laminated together at step 122. Lamination may occur through the use of pressure and adhesive, through the use of a heat shrink process or other techniques known in the art. Finally, the laminate may be die cut into a particular shape or design based on the original order parameters received at the beginning of the process. The die cutting may be accomplished through the use of mechanical die cutting or application of energy in one or more of the visible spectrums. Once the laminate has been completed, the process ends.

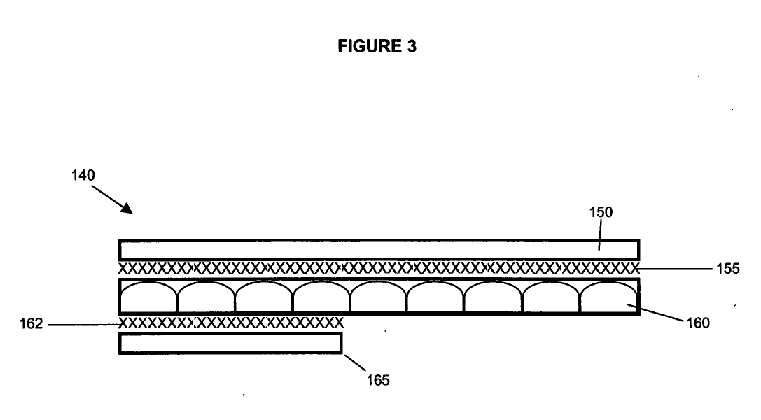

Reference is now directed at FIG. 3 of the present invention which provides a cross section of an exemplary laminate prepared using the system and method discussed herein. The laminate generally depicted by reference to numeral 140 has a top printable sheet 150 that is secured such as by adhesive 155 to a core of material 160. As provided in the FIGURE the core 160 is a corrugated material, but it should be understood that the core may be any material suitable for the purposes described herein.

FIG. 3 also shows a second printable sheet 165 that is secured by adhesive 162 to the core 160. As provided in the FIGURE, only a portion of the core 160 is covered by the second printable sheet 165. The printable sheet may occupy all of the available surface area of the core or only portions of the core depending on the requirements of the job parameters.

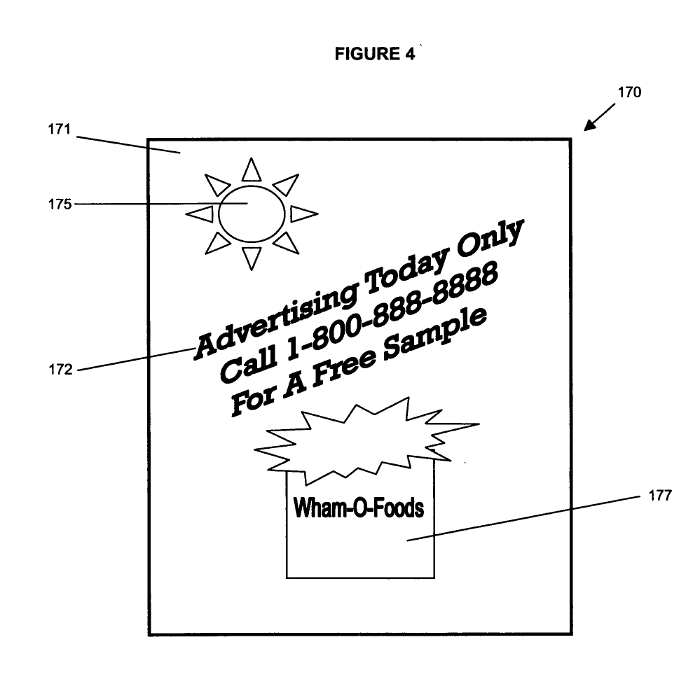

FIG. 4 illustrates a front view of an exemplary laminate 170 that is prepared in accordance with the process and system described herein. The laminate 170 top sheet 171 is printed with textual information 172 as well as graphical depictions 175 and 177 in order in this example to provide an advertising board.

The invention can be used to create advertising media, marketing collateral, point of sale displays and the like. Point of sale displays can include various promotional “talkers” such as those that may appear on a floor, wall or shelf of a retail or wholesale outlet.

Through the use of the present invention, conventional providers of business communications can now significantly increase the types of products that they are capable of producing without making significant expenditures on new equipment. In addition, the system and method of the present invention can be used to create individual or personalized marketing information, such as shown in FIG. 4 in which a particular promotion can be announced, and a specific product showcased by a retail outlet. The degree of personalization that is possible by the present invention is not limited and virtually any amount of creative advertising or marketing material can be added and a laminate created.

It will thus be seen according to the present invention a highly advantageous system and method for producing highly personalized laminate from a number of available substrates has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A system for producing business communication laminates in small to medium quantities, comprising;
an order entry device for matching order criteria obtained from a first source to available order parameters located at a second source that is distinct from said first source;
a high resolution imaging device located at said second source;
a database containing a number of said order parameters for producing a high resolution laminate;
a computer connected to said high resolution imaging device, said order entry device and said database, said computer providing a series of printing instructions to said high resolution imaging device based on said order parameters obtained from said database;
a first group of materials including a number of individual printable sheets with each sheet having a first basis weight;
a second group of individual materials having distinct properties from said first group of materials said distinct properties including basis weight;
a pre-laminate manufacturing unit for juxtaposing a printed sheet from said first group on at least one material from said second group; and
at least one laminating nip for laminating said printed sheet from said first group to said at least one material selected from said second group to create a point of sale business communication laminate having a high resolution image.

2. A system as recited in claim 1, wherein said basis weight of each of said printable sheets of said first group of materials ranges from ten to fifty pounds.

3. A system as recited in claim 1, wherein said basis weight of each individual material of said second group ranges from fifty to one hundred and fifty pounds.

4. A system as recited in claim 1, wherein said system further includes a die cutting machine for cutting said laminate into a shaped configuration.

5. A system as recited in claim 4, wherein said die cutting machine is a laser die cutting unit.

6. A system as recited in claim 4, wherein said die cutting machine is connected to said computer.

7. A system as recited in claim 1, wherein said high resolution imaging device creates an image having a resolution of greater than about 150 lines per inch.

8. A system as recited in claim 1, wherein said point of sale business communication laminate is selected from a group including consumer goods packaging, advertising materials, marketing collateral and combinations thereof.

9. A system as recited in claim 1, wherein said system includes a request solicitation module for soliciting orders from a group of predetermined distributors of business communication materials.

10. A method for producing business communications for point of sale applications, including the steps of;
providing a first database, said database including a number of job production parameters available at a manufacturing site;
collecting job production information from a first source at a site distinct from said manufacturing site;
comparing said job production information from said first source to said job production parameters;
creating imaging information based on said job production information and said job production parameters;
supplying a first group of printable materials, said printable materials having a basis weight ranging from ten to fifty pounds;
selecting a material from a second group of materials for forming a supporting core based on said job production information, said second group of materials having a basis weight that is different than said first group;
producing a high resolution image on at least one printable sheet from said first group, said image having a resolution of greater than about 150 lines per inch;
juxtaposing said at least one printable sheet on a material selected from said second group; and
laminating said at least one printable sheet to said material from said second group to create a laminated point of sale business communication product.

11. A method as recited in claim 10, including a further step of cutting said laminate after the step of laminate.

12. A method as recited in claim 10, including a further step of modifying said job production information after the step of comparing said job production information from said first source to said job production parameters.

13. A method as recited in claim 10, wherein said point of sale business communication product is selected from a group including consumer goods packaging, advertising materials, marketing collateral and combinations thereof.

14. A method as recited in claim 10, including a further step of calculating delivery parameters of said point of sale business communication laminate at any time prior to the step of laminating.

15. A method as recited in claim 10, including a further step of soliciting point of sale business communication laminate orders from a group of distributors of business communication products at any time prior to the step of laminating.

16. A method as recited in claim 10, including a further step of printing a second printable sheet and applying said second printable sheet to a face of said material opposite that of said first printable sheet.

17. A system for producing personalized business communication laminates, comprising;
a pre-determined group of printable sheets, with each sheet having a first thickness;
a pre-selected group of base sheets, with each base sheet having a second thickness, distinct from said first thickness;
an order confirmation system, including
a database containing a number of available manufacturing parameters and for determining available materials for forming a business communication laminate;
a computer connected to said database for matching said manufacturing parameters in response to a request for production of a business communication laminate and for creating a manufacturing sequence;
a high resolution imaging device for printing a high resolution image on at least one printable sheet in response to commands received from said computer;
a post printing station for laminating said at least one printable sheet to one of said base sheets to create a business communication laminate; and
a laser die cutting station for cutting said business communication laminate in connection with said request.

18. A system as recited in claim 17, wherein said system includes a delivery calculation module for determining delivery parameters for said business communication laminate.

19. A system as recited in claim 17, wherein said system includes a request solicitation module for soliciting requests from a group of predetermined distributors of business communication materials.

20. A system as recited in claim 17, wherein said system includes vision inspection system connected to said computer for confirmation of said manufacturing parameters in response to said request.
